(19) United States
(12) Patent Application Publication
(10) Pub. No.: US 2024/0149789 A1
(43) Pub. Date: May 9, 2024

(54) ELECTRONIC CONTROL UNIT AUDIBLE WARNING SYSTEM WITH FULL PERFORMANCE CONDITION WORKING SUPPLY

(71) Applicant: SEGER SES VE ELEKTRIKLI GEREÇLER SANAYI ANONIM SIRKETI, Osmangazi, Bursa (TR)

(72) Inventors: Göknur SETREKLI, Osmangazi, Bursa (TR); Naciye GÜLER, Osmangazi, Bursa (TR); Mehmet KORAL, Osmangazi, Bursa (TR); Ibrahim ÖZBAYRAK, Osmangazi, Bursa (TR)

(21) Appl. No.: 18/549,079

(22) PCT Filed: Feb. 23, 2023
(86) PCT No.: PCT/TR2023/050177

§ 371 Date: Sep. 5, 2023

(30) Foreign Application Priority Data
Apr. 21, 2022 (TR) 2022/006438

(51) Int. Cl. B60Q 5/00; G10K 9/22

(52) U.S. Cl. CPC B60Q 5/00; G10K 9/22

(57) ABSTRACT

Disclosed is a system ensuring that audible warning devices can be used at the most appropriate performance for all vehicle sizes, providing the opportunity to intervene in the problems that may occur during the usage phases and designed to ensure the long-lasting and high-quality use of the finished horns.

### TECHNICAL AREA

The invention, it is related to the development and/or improvement of its features compared to the existing vehicle being able to interfere with the audible warning devices in the vehicles from the outside environment.

### PRIOR ART

On an electronically controlled horn, there is a micro processor that manages the operation of the horn. In this micro processor in embedded software, horn at nominal conditions must have frequency and PWM contains the codes of the values. Inside the electronical control unit in micro processor it controls the mosfet according to these values. It enables the circuit to be opened and closed. In this way a warning sound is generated in vehicles by operating the horn.

Frequency and PWM values determined to operate the horn, inside the horn mechanical parts dimensional and mounting dimensions determined on the basis of nominal values. The same software is embedded before the horn is mounted on the microprocessor.

However each of mechanical part to create horn according to production techniques at the design stage outside the nominal dimensions there are minimum and maximum usage values determined. Moreover these mechanical parts, to create the horn brought together is assembled. There are also minimum and maximum dimensions of the assembly dimensions determined during the design phase.

Due to all these tolerances same software on every horn it does not allow working at the same performance.

In some audible warning devices that are currently designed and used at the same time there are some disadvantages in terms of functionality and ease of intervention.

### Some of Those

The most important disadvantage of the current system, in the audible warning device and electrical control unit with software installed, for not be damaged by heavy road and environmental conditions for located in an area closed to outside contact it also eliminates the possibility of interfering with the software.

Another disadvantage of the current system in horns that are produced and actively used since software cannot be interfered with there are problems in adapting to the equipment provided by different production types. This causes the quality of the sound warning devices to decrease.

In order to eliminate the mentioned disadvantages designed audible warning parts, of the electronic control unit it is intended to be made in different tolerances and sizes. However, the quality of the device increases when the tolerance range is provided.

Considering previous inventions and designs, “Motorcar horn with controllable sound volume” (CN203157838U) audible warning of your device depending on the external environment it is in, it is aimed to increase the sound quality and loudness. However, the said invention is not preferred as it may cause noise and discomfort in social areas.

### OBJECTIVE OF THE INVENTION

Purpose of the invention, with designed spacer audible warning devices open to outside interference it is the adjustment of the areas where it is used according to the measurement and tolerance measures.

Another purpose of the invention, since the software of the audible warning devices may be interfered with, every sound warning device produced will be used with maximum efficiency.

Another purpose of the invention, is to eliminate product losses due to the increase in product quality and service life.

### BRIEF DESCRIPTION OF THE INVENTION

Invention, from the vehicle electrical voltage transmitting to the electronic control unit it comprises at least one input terminal and at least one output terminal that transmits the electrical voltage from the electronic control unit to the horn coil.

It consists of a software embedded in the horn computer and an electronic control unit that includes a manager and micro processor, mosfet and similar active and passive electronic components.

The electronic control unit includes the input terminal slots, which ensure the correct positioning and stability of the input terminals on the electronic control unit, and the electronic control unit output terminal housing, which ensures the correct positioning and stability of the output terminals on the electronic control unit.

It completely covers all open parts of the socket to protect the electronic control unit from external condition and completely isolating the electronic control unit from the external environment it consists of a socket where the electronic control unit is located and the horn is electrically connected to the vehicle.

Trunk includes a physical connection terminal that provides the physical connection between the electronic control unit and the existing external environment and enables the software to be transmitted to the said electrical control unit.

By ensuring that said physical connection terminal is correctly positioned on said electronic control unit and by contacting it with the micro processor it contains the physical connection pin slot of the electronic control unit, which provides the possibility to interfere with the existing software.

It consists of a over socket physical connection slot, which ensures the correct positioning of the said physical connection terminal on the socket and serves as a receptacle for the said physical connection terminal to be filled with an insulator and protective filling material to be applied after the software installation process is completed.

In another embodiment of the invention, said physical connection terminal protection from physical effects from the external environment and inside of trunk the pins in question are positioned to prevent them from being damaged by coming into contact with each other it contains an insulator and protective filling material to be applied and a protective wall that prevents it.

In another embodiment of the invention the physical connection terminal in question, to ensure that it is positioned on the electrical control unit it contains the physical connection pin slot of the electrical control unit fixed on the electrical control unit.

### BRIEF DESCRIPTION OF THE FIGURES

In FIG. 1, a detailed picture is provided where parts of the buzzer are shown.

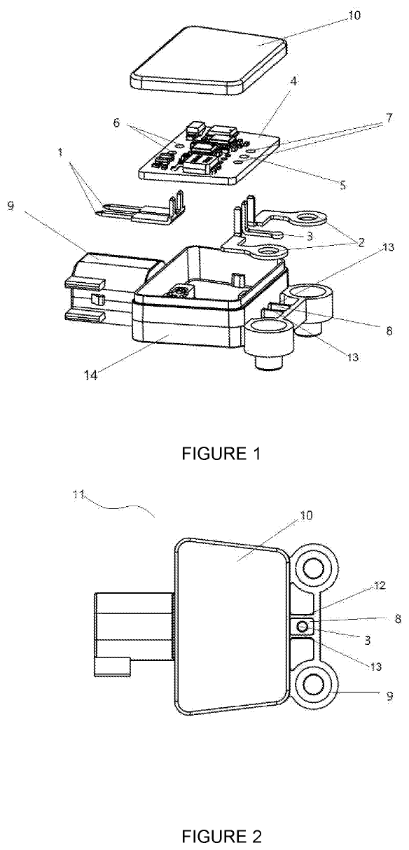

In FIG. 2, the top view of the audible warning device is given.

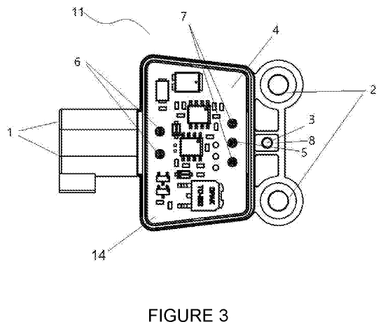

In FIG. 3, the top view of the electrical control unit is given.

### EXPLANATION OF REFERENCE NUMBERS IN THE FIGS.

1. Input terminal
2. Output terminal
3. Physical connection terminal
4. Electronical control unit
5. Electronical control unit physical connection pin slot
6. Electronical control unit input terminal slot
7. Electronical control unit output terminal slot
8. Over socket physical connection slot
9. Socket
10. Cover
11. Audible warning device
12. Pin slot
13. Protection walls
14. Trunk

### DETAILED DESCRIPTION OF THE INVENTION

This detailed description, while continuing to use audible warning devices (11) with outside for connection controlled has been revealed.

The invention, it is designed to use the horn at maximum level and performance in all existing areas.

The invention, generally describes a horn structure. Before installing the horn cover (10) is used to prevent the electronic components from being affected by the outdoor temperature. The said cover (10) is mounted to the open area socket (9). So the electronical unit control (4) makes it completely isolated from the outside.

For the horn to work, the continuous electrical voltage from the vehicle must be transmitted to the horn coil intermittently with certain frequency and PWM values.

Continuous electrical voltage coming from the vehicle, it is sent to the electronic control unit input terminal sockets (6) via the input terminals (1). The design and geometric dimensions of these slots, made to provide physical connection input terminals (1) and electronical control unit (4). The electrical voltage of the horn coming to the electronic control unit (4) operates active and passive electronic components with embedded software, by activating the micro processor located on the electronic control unit (4). Output terminals (2) located inside the electronic control unit output terminal slots (7) makes the horn work electrical voltage is transmitted to the coil of the horn. Differences in tolerance ranges caused by production make up differences in the working performance of each horn. For each horn software different a variable must be defined in order to eliminate the differences observed at the end of production. Horn socket (9) with cover (10) is in the closed position at the end of production. A physical contact zone not available for this reason, it is necessary to interfere with the embedded software in the electronic control unit (4) located in the socket (9). With the invention best software will be determined with a system developed for horn measuring various values. The system is sending with the physical connection terminal (3), which is positioned partly outside the socket (9) and partly inside the socket (9), the most appropriate software can be transferred to the electronic control unit (4). Physical connection terminal (3) nested on the outside, into the physical connection socket (9).

The most suitable software with a system will be determined developed for horn measuring various values with together invention. Physical connection terminal (3), partly positioned outside the socket (9) and partly inside the socket (9) is sending the best software electrical control unit (4) in this system. Physical connection terminal (3) nested in the outside over socket physical connection slot (8).

Over socket physical connection slot (8) consists of two protection walls (13). Said of protection walls (13) it is designed to eliminate the contact of the pins with each other during operation in order to fit the pin on which the physical connection terminal (3) is mounted, to protect the pin slot (12) from the physical effects that may come from the external environment and to be connected to the trunk (14). The horn will be made ready at the same time, the latest software is updated. Next a reservoir to ensure that the insulating filler material is applied in the correct position and amount to prevent software tampering again will be created.

Physical connection terminal (3) transmits the software it receives by contacting the system to the electronic control unit (4) via the electronic control unit physical connection pin slot (5) of the electronic control unit (4). So physical connection terminal (3) provides the correct software for the horn is loaded into the micro processor.

The electronical control unit physical connection pin slot (5) was designed it has a geometry that can make full physical contact with the electronic control unit (4) and ensures that the physical connection terminal (3) is in the correct position and fixed. Conductive paths inside the electronic control unit (4) fully connected with its lateral surfaces the electronical control unit physical connection pin slot (5). The software to be loaded reaches the micro processor will be provided in this way, the physical connection terminal (3) is fully contacted with the conductive paths.

1. A system comprising at least one input terminal that transmits an electrical voltage coming from a vehicle to an electronic control unit and containing at least one output terminal that transmits the electrical voltage from the electronic control unit to a horn coil, a micro processor, which manages the operation of the horn with a software embedded in it, comprising at least one electronic control unit containing mosfet and similar active and passive electronic components, electronic control unit input terminal slots that ensure the correct positioning and stability of the input terminals on the electronic control unit and it contains an electronic control unit output terminal slot, which ensures the correct positioning and stability of the output terminals on the electronic control unit comprising at least one cover that completely closes all the open parts of a socket in order to protect the electronic control unit from external environmental conditions and completely insulates the electronic control unit from the outside environment, an audible warning device comprising at least one socket where the electronic control unit is located and the electrical connection of the horn with the vehicle is, further comprising:
a physical connection terminal, which provides the physical connection of a trunk between the electronic control unit and the existing external environment, and transmits the software to the said electrical control unit;
an electronic control unit physical connection pin slot, which allows the said physical connection terminal to be correctly positioned on the said electronic control unit and to make contact with the micro processor, allowing it to interfere with the existing software;
wherein after the software installation process is completed on the said physical connection terminal, which ensures the correct positioning of the said physical connection terminal on the socket to be filled with insulator and protective filling material over socket physical connection slot.

2. Audible warning device according to claim 1, comprising a protection wall to prevent damage contacting each other of said physical connection terminal pins connected with the said physical connection terminal, which is mounted inside the trunk.

3. Audible warning device according to claim 2, wherein the said physical connection terminal, which is mounted inside the trunk protection, protection wall containing insulator and protective filling to be applied against physical effects that may come from the external environment.

4. Audible warning device according to claim 1, wherein the electrical control unit physical connection pin slot is fixed on the electrical control unit in order to ensure that the said physical connection terminal is positioned on the electrical control unit.
